(19) United States
(12) Patent Application Publication
(10) Pub. No.: US 2008/0105223 A1
(43) Pub. Date: May 8, 2008

(54) Barrel-type internal combustion engine

(76) Inventors: Larry Kubes, Climax, MI (US); Pierre-Louis Vernhes, Chatillon (FR); Chris Lambert, Troy, MI (US); Jeff Klaver, Ypsilanti, MI (US); Peter Campbell, Clarkston, MI (US)

Correspondence Address: LARRY KUBES, 6378 S. 44TH STREET, CLIMAX, MI, 49034, US

(21) Appl. No.: 11/595,324

(22) Filed: Nov. 8, 2006

(51) Int. Cl. F02B 75/00

(52) U.S. Cl. 123/56.1

(57) ABSTRACT

An engine, e.g., a cam drive, barrel-type internal combustion engine, that includes: a main drive shaft defining a longitudinal axis; a sinusoidal main drive cam rigidly attached to the main drive shaft; a plurality of cam members that are in contact with the sinusoidal main drive cam and that are configured to follow the sinusoidal main drive cam, wherein rotation of the sinusoidal main drive cam corresponds to reciprocating linear movement of each of the plurality of cam members in a direction parallel to the longitudinal axis; for each cam member, a pair of linear pistons disposed on opposite sides of the cam member for reciprocating linear movement within respective cylinder bores.

### CROSS-REFERENCE TO RELATED APPLICATIONS

This application is related to U.S. patent application Ser. No. 11/493,710, entitled “Barrel-Type Internal Combustion Engine,” filed Jul. 24, 2006, U.S. patent application Ser. No. 11/523,188, entitled “Generator and/or Motor Assembly”, filed Sep. 18, 2006, and U.S. Provisional Patent Application Ser. No. 60/702,023, entitled “Barrel-Type Internal Combustion Engine,” filed Jul. 23, 2005, each of which is expressly incorporated herein in its entirety by reference thereto.

### FIELD OF THE INVENTION

The present invention relates to internal combustion engines, and more particularly, to a cam drive, barrel-type internal combustion engine.

### BACKGROUND INFORMATION

Various types of internal combustion engines are conventional. Some common types of internal combustion engines, e.g., Otto-, diesel-, Miller-, Atkinson-cycle, etc., may utilize pistons and connecting rods to drive a crankshaft. Rotary internal combustion engines, also referred to as “Wankel” engines, replace the reciprocating motion of the pistons by rotational or eccentric motion. The present application relates to a so-called “barrel-type” internal combustion engine, a third family of internal combustion engines, in which combustion takes place in cylinders to move reciprocating pistons.

Like most internal combustion engines, barrel-type engines also convert combustion energy into rotational energy. In barrel-type engines, the linear motion of a piston is transferred directly into rotational motion through a sinusoidal-shaped main drive cam resulting in higher efficiencies, lighter weight and less moving parts than conventional Otto engines. Mechanical power is transmitted from each piston through an associated cam driver/follower to the main drive cam mounted on the output drive shaft.

There are a variety of configurations of cam drive barrel-type internal combustion engines. However, none of the existing cam drive barrel-type internal combustion engines is believed to provide adequate performance, efficiency, versatility and compactness.

### SUMMARY

Example embodiments of the present invention provide an engine, e.g., a cam drive, barrel-type internal combustion engine. The engine may include: a main drive shaft defining a longitudinal axis; a sinusoidal main drive cam rigidly attached to the main drive shaft; a plurality of cam members, e.g., rollers, that are in contact with the sinusoidal main drive cam and that are configured to follow the sinusoidal main drive cam, rotation of the sinusoidal main drive cam corresponding to reciprocating linear movement of each of the plurality of cam members in a direction parallel to the longitudinal axis; for each of the cam members, a pair of linear pistons disposed on opposite sides of the cam member for reciprocating linear movement within respective cylinder bores; and a control system for selectively using cam members located on a first side of the sinusoidal main drive cam for generating torque and using cam members located on a second side of the sinusoidal main drive cam for a function other than generating torque.

An engine may include: a cylinder bore having a piston disposed within; an intake valve coupled to a first rotatable arm and configured to engage a respective intake valve seat in communication with the cylinder bore; and an exhaust valve coupled to a second rotatable arm and configured to engage a respective exhaust valve seat in communication with the cylinder bore, the intake and exhaust valves actuatable, such that combustion pressure moves the piston into engagement with a sinusoidal drive cam mounted on a rotatable drive shaft, the first and second rotatable arms being rotatable about, e.g., a single pivot.

A barrel engine may include: a rotatable shaft; a cam disc mounted to the rotatable drive shaft, the cam disc having a surface that includes a planar region and a non-planar region; an actuation mechanism in contact with the surface; a valve coupled to, and configured to be actuated by, the actuation mechanism such that the valve is caused to be in a first one of an open and a closed state when the actuation mechanism is in contact with the planar region of the surface, and the valve is caused to be in a second one of an open and a closed state when the actuation mechanism is in contact with the non-planar region of the surface.

A barrel engine may include: a rotatable shaft; a cam disc mounted to the rotatable drive shaft, the cam disc having first and second surface, each surface including a planar region and a non-planar region; an actuation mechanism in contact with the first and second surfaces; a valve coupled to, and configured to be actuated by, the actuation mechanism such that the valve is caused to be in a first one of an open and a closed state when the actuation mechanism is in contact with the planar region of the surfaces, and the valve is caused to be in a second one of an open and a closed state when the actuation mechanism is in contact with the non-planar region of the surfaces.

An engine may include a sinusoidal drive cam mounted on a rotatable drive shaft, which includes: a tubular rod mounted to a housing, an interior bore of the tubular rod being in fluid communication at both ends with respective sources of lubrication fluid; a piston configured for reciprocating movement within a respective cylinder bore for engaging and causing rotation of the sinusoidal drive cam and drive shaft, the piston defining an interior region; a sliding member mounted on the tubular rod and configured to slide thereon, the sliding member defining a fluid path between the interior region of the piston and the interior bore of the tubular rod.

An engine may include: a main drive shaft defining a longitudinal axis, the main drive shaft including a first drive shaft portion detachably coupled to a second drive shaft portion; a sinusoidal main drive cam rigidly attached to the main drive shaft; a plurality of cam members that are in contact with the sinusoidal main drive cam and that are configured to follow the sinusoidal main drive cam, rotation of the sinusoidal main drive cam corresponds to reciprocating linear movement of each cam member in a direction parallel to the longitudinal axis; and for each cam member, a pair of linear pistons disposed on opposite sides of the cam member for reciprocating linear movement within respective cylinder bores.

An engine may include: a main drive shaft defining a longitudinal axis; a sinusoidal main drive cam non-rotatably attached to the main drive shaft; four cylinder bores symmetrically arranged both radially and circumferentially about the longitudinal axis, a first portion of each cylinder bore being disposed on a first side of the sinusoidal main drive cam and a second portion of each cylinder bore being disposed on a second side opposite the first side of the sinusoidal main drive cam; a linear piston disposed in the first and second portions of each cylinder bore; mounted to each piston, a cam member that engages the sinusoidal main drive cam, wherein reciprocating linear movement of each piston and its respective cam member in a direction parallel to the longitudinal axis causes the respective cam member to rotate the sinusoidal main drive cam and the main drive shaft, such that the forces generated within the engine are substantially balanced, e.g., radial combustion forces are substantially or completely eliminated and axial combustion forces are opposed to each other such that net resultant forces are substantially or completely eliminated, so as to minimize engine vibration.

An engine may include: a main drive shaft defining a longitudinal axis; a sinusoidal main drive cam non-rotatably attached to the main drive shaft; four cylinder bores symmetrically arranged both radially and circumferentially about the longitudinal axis, a first portion of each cylinder bore disposed on a first side of the sinusoidal main drive cam and a second portion of each cylinder bore disposed on a second side opposite the first side of the sinusoidal main drive cam; a linear piston disposed in the first and second portions of each cylinder bore; mounted to each piston, a cam member that engages the sinusoidal main drive cam, wherein reciprocating linear movement of each piston and its respective cam member in a direction parallel to the longitudinal axis causes the respective cam member to rotate the sinusoidal main drive cam and the main drive shaft, such that the forces generated within the engine are substantially balanced, e.g., combustion in two opposed cylinders at the same time, so as to minimize thrust forces on the main drive shaft.

An engine may include: a main drive shaft defining a longitudinal axis; a sinusoidal main drive cam non-rotatably attached to the main drive shaft; a cylinder bore, a first portion of the cylinder bore being disposed on a first side of the sinusoidal main drive cam and a second portion of the cylinder bore being disposed on a second side opposite the first side of the sinusoidal main drive cam; a pair of linear pistons, each pair of linear pistons disposed in a respective one of the first and second portions of the cylinder bore; mounted to each piston, a roller that engages the sinusoidal main drive cam, wherein reciprocating linear movement of each piston and its respective roller in a direction parallel to the longitudinal axis causes the respective roller to be in rolling contact with the sinusoidal main drive cam for rotating the sinusoidal main drive cam and the main drive shaft.

An engine may include: a rotatable shaft; a cam disc mounted to the rotatable drive shaft, the cam disc having a surface that includes a planar region and a non-planar region; a rotatable arm; a pair of rollers mounted to the rotatable arm, each one of the pair of rollers being in rolling contact with the surface; a valve coupled to, and configured to be actuated by, the rotatable arm such that the valve is configured to be in a first one of an open and a closed state when at least one of the pair of rollers is in contact with the planar region of the surface, and the valve is configured to be in a second one of an open and a closed state when at least one of the pair of rollers is in contact with the non-planar region of the surface.

An engine may include: a main drive shaft defining a longitudinal axis; a sinusoidal main drive cam non-rotatably attached to the main drive shaft; a cylinder bore, a first portion of the cylinder bore being disposed on a first side of the sinusoidal main drive cam and a second portion of the cylinder bore being disposed on a second side opposite the first side of the sinusoidal main drive cam; a pair of linear pistons, each pair of linear pistons disposed in a respective one of the first and second portions of the cylinder bore; mounted to each piston, a pair of rollers that engages the sinusoidal main drive cam, wherein reciprocating linear movement of each piston and its respective rollers in a direction parallel to the longitudinal axis causes the respective rollers to be in rolling contact with the sinusoidal main drive cam for rotating the sinusoidal main drive cam and the main drive shaft.

An engine may include: a main drive shaft defining a longitudinal axis; a sinusoidal main drive cam non-rotatably attached to the main drive shaft; a cylinder bore, a first portion of the cylinder bore being disposed on a first side of the sinusoidal main drive cam and a second portion of the cylinder bore being disposed on a second side opposite the first side of the sinusoidal main drive cam; a pair of linear pistons, each pair of linear pistons disposed in a respective one of the first and second portions of the cylinder bore; mounted to each piston, a first roller and a second roller, wherein reciprocating linear movement of each piston and its respective roller in a direction parallel to the longitudinal axis causes the respective roller to be in rolling contact with the sinusoidal main drive cam for rotating the sinusoidal main drive cam and the main drive shaft, wherein the second rollers is caused to intermittently engage the sinusoidal main drive cam based upon, e.g., a speed of the first roller, a position of a cam, a load, etc.

An engine may include: a main drive shaft defining a longitudinal axis; a sinusoidal main drive cam rigidly attached to the main drive shaft; a plurality of cam members that are in contact with the sinusoidal main drive cam and that are configured to follow the sinusoidal main drive cam, wherein rotation of the sinusoidal main drive cam corresponds to reciprocating linear movement of each of the plurality of cam members in a direction parallel to the longitudinal axis; for each cam member, a pair of linear pistons disposed on opposite sides of the cam member for reciprocating linear movement within respective cylinder bores; and bearings disposed within the cylinder bores for maintaining the reciprocating linear movement of the pair of linear pistons within the respective cylinder bores in a direction parallel to the longitudinal axis.

A system may include: an engine that includes: a main drive shaft defining a longitudinal axis, the main drive shaft having a first longitudinal portion and a second longitudinal portion; a sinusoidal main drive cam non-rotatably attached to the main drive shaft; a cylinder bore, a first portion of the cylinder bore being disposed on a first side of the sinusoidal main drive cam and a second portion of the cylinder bore being disposed on a second side opposite the first side of the sinusoidal main drive cam; a pair of linear pistons, each pair of linear pistons disposed in a respective one of the first and second portions of the cylinder bore; and mounted to each piston, a cam member that engages the sinusoidal main drive cam, wherein reciprocating linear movement of each piston and its respective roller in a direction parallel to the longitudinal axis causes the respective cam member to be in contact with the sinusoidal main drive cam for rotating the sinusoidal main drive cam and the main drive shaft. The system may also include a first generator (or other power consumption device, e.g., pump, pulley, propeller, etc.) coupled to the first longitudinal portion of the main drive shaft and a second generator coupled to the second longitudinal portion of the main drive shaft.

The engine may include bearings, e.g., thrust bearings and shaft bearings, for maintaining a position of the main drive shaft. Each pair of linear pistons may have a finish for reducing friction experienced by movement of the linear piston shaft, e.g., a low wear coating.

The engine may include four pairs of pistons, each piston disposed within a respective one of eight cylinder bores, wherein the cylinders are positioned in a generally circular pattern about the main drive shaft. Mechanical power is transmitted from each piston to its respective cam member and from the respective cam member to the sinusoidal main drive cam being attached to the main drive shaft.

The engine may also include a block/head assembly including intake valves configured to supply intake air to respective cylinder bores and exhaust valves configured to exhaust respective cylinder bores. The valves may be held in a pre-stressed closed position by a compressed spring. The exhaust block/head assembly may be made of a temperature-resistant material, such as aluminum, steel or high performance ceramic coated plastic, etc. The engine may be configured such that a first one of the pair of pistons operates to produce torque, wherein the second one of the pair of pistons operates to perform a different task, e.g., pumping hydraulic fluids or pneumatics, etc.

Further aspects and features of example embodiments of the present invention are described in more detail below with reference to the appended Figures.

### BRIEF DESCRIPTION OF THE DRAWINGS

FIG. 1 is a cross-sectional view illustrating some of the features of an engine according to an example embodiment of the present invention;

FIG. 2(a) through (d) are perspective views that illustrates the main drive cam;

FIG. 3 is a longitudinal or axial view of a block/head assembly;

FIG. 4 illustrates additional details of a valve arrangement;

FIG. 5(A) is a perspective view of a cam disc that includes a single surface;

FIG. 5(B) is a perspective view of a cam disc that includes a three surfaces;

FIG. 6 is a longitudinal or axial view of a block/head assembly;

FIG. 7 is a partial view of the engine which illustrates certain additional details of the piston and main drive cam arrangement;

FIG. 8 is a partial cross-sectional view of the engine which illustrates further details of the piston and main drive cam arrangement;

FIGS. 9(A) and 9(B) illustrate the main drive cam in various rotational positions;

FIG. 10 illustrates an arrangement in which a gimbal includes two rollers;

FIG. 11 illustrates an arrangement in which the linear pistons include, on each side of the main drive cam, a pair of rollers;

FIG. 12 illustrates an arrangement that includes a main roller and a secondary roller;

FIG. 13(a) is a longitudinal cross-sectional view, and FIG. 13(b) is a side cross-sectional view, that show a slide member engaging a piston shank;

FIG. 14(a) is a perspective view of a cam disc that has upper and lower surfaces;

FIG. 15(a) illustrates a linear piston having a slotted depression;

FIG. 16 illustrates a main drive cam having a single lobe;

FIG. 17 illustrates a main drive cam having three lobes;

FIG. 18 illustrates an arrangement of the engine which is configured with a built-in generator/motor;

FIG. 19 illustrates a method by which the cam may be milled using a three-axis milling device;

FIGS. 20(a) through (d) illustrate performance characteristics that may be achieved by using varying shapes of, e.g., the main drive cam; and

FIGS. 21 and 22 illustrate schematically a system, including a control arrangement, in which the engine may be employed.

### DETAILED DESCRIPTION

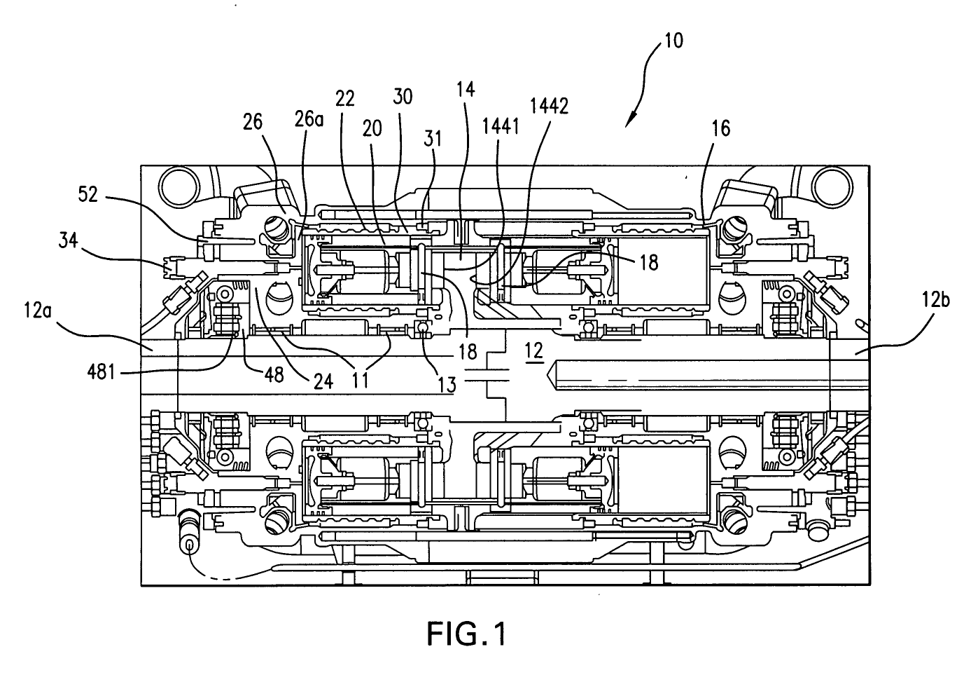

FIG. 1 is a cross-sectional view illustrating some of the features of an engine 10, e.g., a cam drive, barrel-type internal combustion engine, according to an example embodiment of the present invention. FIG. 1 illustrates the engine 10 including a main drive shaft 12 defining a longitudinal axis. The main drive shaft 12 may be formed of two shaft portions 12a and 12b that are connected to each other via a suitable coupling arrangement. Position of the main drive shaft 12 may be maintained with thrust bearings 13 and main shaft bearings 11. Rigidly attached to the main drive shaft 12 is a sinusoidal main drive cam 14. The main drive cam 14 may have varying shapes, dimensions and material properties based on, e.g., cost limitations or performance requirements, such as torque, fuel type, speed, etc., as set forth in additional detail below. It should be recognized that, while the main drive cam 14 is described herein as being sinusoidal, the main drive cam 14 may alternatively have a profile that is not sinusoidal, the present invention including any conceivable shape. The main cam drive material may include, e.g., alcoat, steel, Timken 3311, maraging steel, silicon nitride, etc.

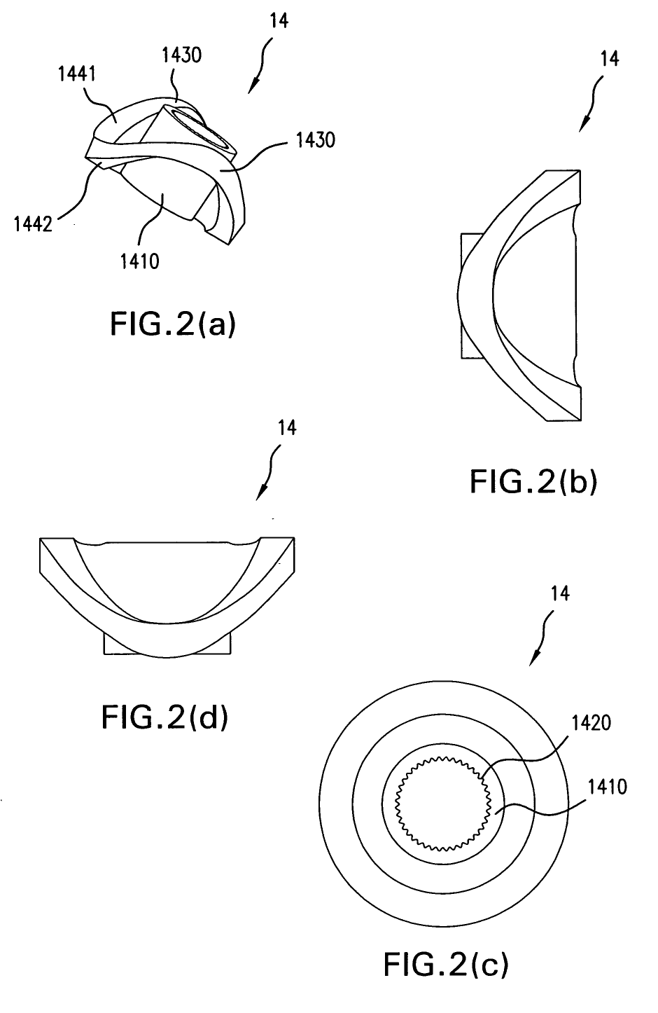

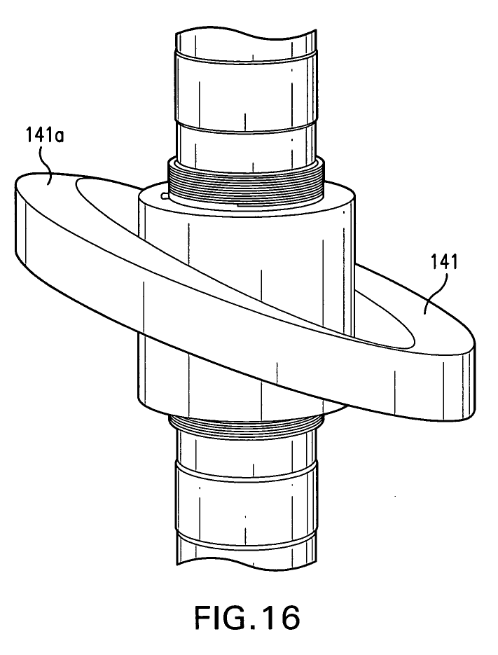

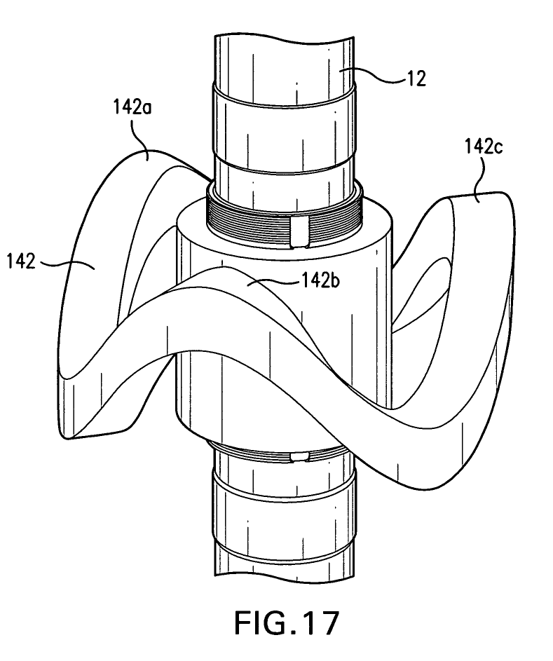

The main drive cam 14 has a profile such as that shown in FIGS. 2(a) through (d). Other profiles, such as those shown in FIGS. 16 and 17, which are described in further detail below, may also be employed. Referring to FIG. 2(a) through (d), the main drive cam 14 is shown having a sleeve 1410 with teeth 1420 for non-rotatably engaging corresponding teeth of the main drive shaft 12. The main drive cam 14 thus has two lobes 1430 that define curved surfaces 1441 and 1442. The curved surfaces 1441 and 1442 are disposed on opposite longitudinal sides of the main drive cam 14, each being configured so as to provide a continuous surface.

Referring back to FIG. 1, the engine 10 may also include a plurality of cam members 18. The cam members 18 may be, e.g., rollers. The cam members 18 may be made from, or coated with, any appropriate wear-resistant material such as silicon nitride. The cam members 18 are in contact, e.g., rolling contact, with the surfaces 1441, 1442 of the sinusoidal main drive cam 14 and are configured to follow the sinusoidal main drive cam 14. Rotation of the sinusoidal main drive cam 14 causes, or is caused by, reciprocating linear movement of each of cam members 18 in a direction parallel to the longitudinal axis of the main drive shaft 12.

For each cam member 18, the engine 10 includes a pair of linear pistons 20. Each pair of linear pistons 20 is disposed on an opposite longitudinal side of the cam member 18. The pair of linear pistons 20 are connected to each other by a piston shank 21 such that the pair of linear pistons 20 are integrally formed and may move as a single component, as set forth in further detail below. The linear pistons 20 may exhibit low wear properties, such as by super-finishing and/or using low friction coatings such as “Alcoat.” As shown in FIG. 1, an inner longitudinal end of each one of the pair of linear pistons 20, e.g., the end closest to the main drive cam 14, has a respective cam member, e.g., a cam roller 18, mounted therein, the respective cam member 18 being in rolling contact with the surfaces 1441, 1442 of the main drive cam 14. The rolling movement of each one of the cam rollers 18 along the surfaces 1441, 1442 of the sinusoidal main drive cam 14 causes reciprocating linear movement of the pair of linear pistons 20 in the longitudinal direction.

Each pair of linear pistons 20 is disposed and move within a respective cylinder bore 22, a first portion of the cylinder bore 22 being disposed on a first side of the main drive cam 14 and a second portion of the cylinder bore 22 being disposed on a second side of the main drive cam 14, the first and second portions of the cylinder bore 22 being longitudinally aligned relative to each other. The outer longitudinal end of each portion of the cylinder bores 22, e.g., the ends furthest from the main drive cam 14, terminates at a block/head assembly 26.

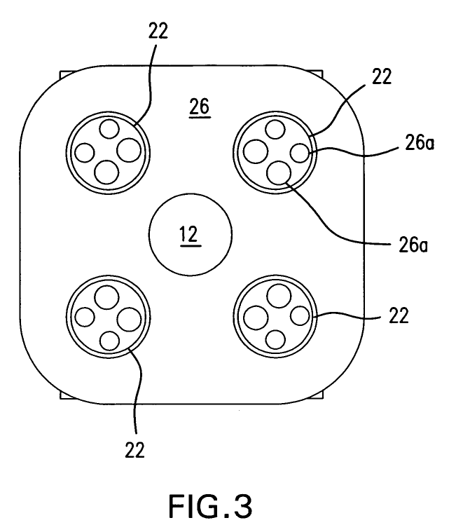

FIG. 3 is a longitudinal view of the block/head assembly 26, showing an arrangement of the four cylinder bores 22 about the central opening for the main drive shaft 12. Referring to FIG. 3, the block/head assembly 26 is shown as having, for each of the four cylinder bores 22, four spaced valve seats 26a formed therein, with each of the four valve seats 26a being in communication with a cylinder bore 22.

Referring back to FIG. 1, each cylinder bore 22 may be provided with a liner 30. The cylinder bores and/or liners may be formed of a temperature-resistant material, e.g., ceramic. The block/head assembly 26 also supports a number of circumferentially-spaced, longitudinally-extending fuel injectors 34 that communicate with the cylinder bores 22. The fuel injectors 34 may be, e.g., piezoelectric driven, low pressure, etc.

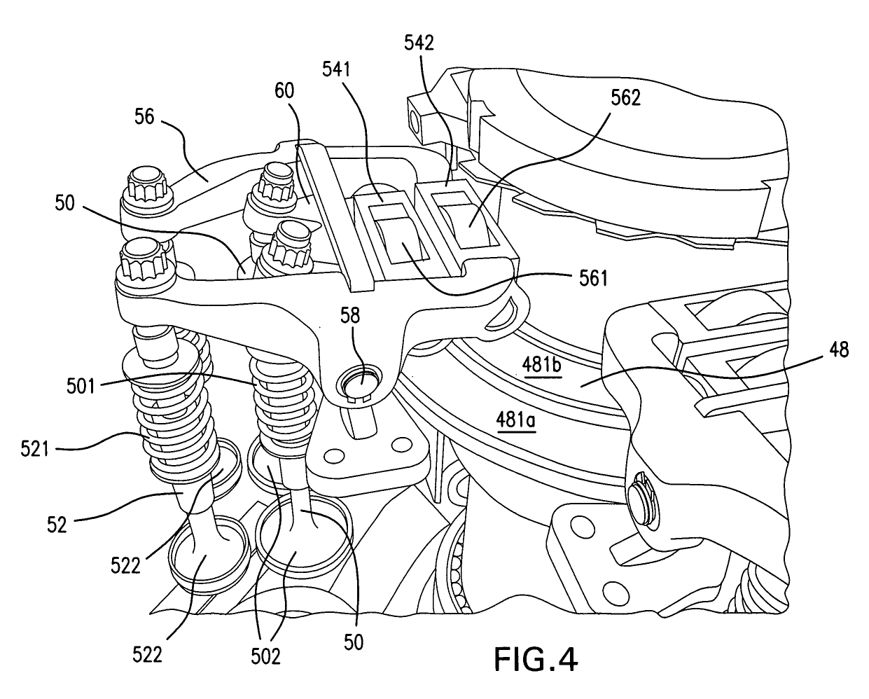

A disc cam 48 having a surface 481 rotates with the shaft 12, and is disposed longitudinally adjacent to the block/head assembly 26. For each cylinder bore 22, there are two intake valves 50 and two exhaust valves 52 that are operated, e.g., opened and closed, via mechanical engagement with the cam surfaces 481. The two intake valves 50 and two exhaust valves 52, and their operation via mechanical engagement with the cam surfaces 481 are illustrated in FIG. 4.

Referring now to FIG. 4, there is shown additional details of the valve arrangement. Specifically, FIG. 4 illustrates the cam disc 48 having a surface 481, the surface 481 including a pair of radially concentric surfaces 481a and 481b. Each of a pair of gimbals 541, 542 includes respective rollers 561, 562. The roller 561 of gimbal 541 is in rolling contact with the cam surface 481a of the cam disc 48. Also, the roller 562 of gimbal 542 is in rolling contact with the cam surface 481b of the cam disc 48.

The gimbal 542 is connected to the pair of exhaust valves 52 via a rotatable arm 56, the rotatable arm 56 being rotatable about a pivot 58. The pivot 58 is mounted to the block/head assembly 26. Each pair of exhaust valves 52 has a respective spring 521 that biases a head 522 of the exhaust valve 52 upwardly into sealed engagement with a respective valve seat 26a. Also, the springs 521 bias outer radial ends of the rotatable arm 56 upwardly, such that the roller 562 mounted to the inner radial end of the rotatable arm 56 is biased downwardly and into continuous rolling contact with the cam surface 481b.

Also, the gimbal 541 is connected to the pair of intake valves 50 via a rotatable arm 60, the rotatable arm 60 being rotatable about a pivot 58. The pivot 58 is mounted to the block/head assembly 26 and may be the same pivot about which the rotatable arm 56 is mounted. Each pair of intake valves 50 has a respective spring 501 that biases a head 502 of the intake valve 50 upwardly into sealed engagement with a respective valve seat 26a. Also, the springs 501 bias outer radial ends of the rotatable arm 60 upwardly, such that the roller 561 mounted to the inner radial end of the rotatable arm 60 is biased downwardly and into continuous rolling contact with the cam surface 481a.

The cam surfaces 481a, 481b are generally planar but include, over a portion of its circumference, a convex region. The convex region of the cam surfaces 481a, 481b, cause rotation of the respective arms 56, 60 at predetermined intervals, thereby operating, e.g., opening and closing, the respective intake and exhaust valves 50, 52 in accordance with a timed sequence. For example, the cam surface 481a may be planar along a portion of its circumference, such that rolling contact of the roller 561 of the gimbal 541 over this planar portion maintains the valve head 502 of the intake valve 50 in sealing contact with a respective valve seat 26a. The convex region of the cam surface 481a may, by the rolling contact of the roller 561 of the gimbal 541 along this region, cause the valve head 502 of the intake valve 50 to be lifted away from its sealing contact with its respective valve seat 26a, thereby permitting the cylinder bore 22 to receive intake air. Once the roller 561 has passed over the convex region of the cam surface 481a and the roller 561 resumes rolling over a generally planar portion of the cam surface 481a, the biasing effect of the spring 501 moves the valve head 502 of the intake valve 50 back into sealing engagement with its respective valve seat 26a.

The cam surface 481b is generally planar over a portion of its circumference, such that rolling contact of the roller 562 of the gimbal 542 over this planar portion maintains the valve head 522 of the exhaust valve 52 in sealing contact with a respective valve seat 26a. The cam surface 481b may also have a convex region over a portion of its circumference, such that rolling contact of the roller 562 of the gimbal 542 over this convex portion lifts the valve head 522 of the exhaust valve 52 away from its sealing contact with its respective valve seat 26a, thereby permitting the cylinder bore 22 to exhaust. Once the roller 562 has passed over the convex region of the cam surface 481b and the roller 562 resumes rolling over the generally planar portion of the cam surface 481b, the biasing effect of the spring 521 moves the valve head 522 of the exhaust valve 52 back into sealing engagement with its respective valve seat 26a.

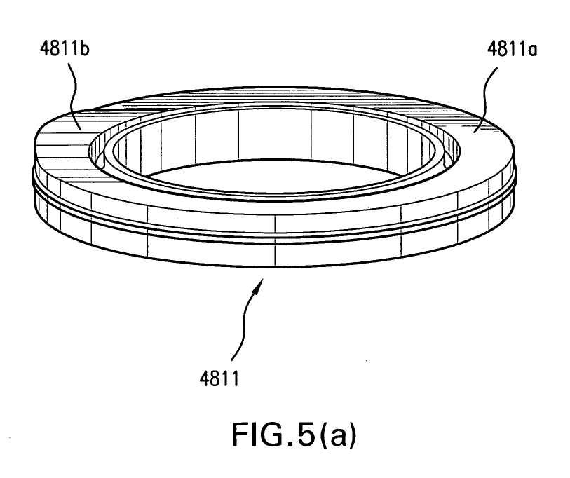

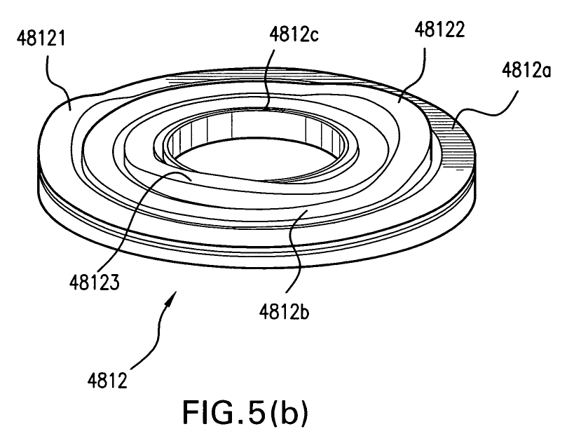

As indicated above, the cam disc 481 may have surfaces 481a, 481b that are generally planar but that may include, over portions of their circumference, a convex region that mechanically actuates the intake and exhaust valves in accordance with a timed sequence, e.g., by causing rotation of the rotatable arms 56, 60 at predetermined intervals, to open and close the respective intake and exhaust valves 50, 52. It should be understood that the cam disc 481 may have any shape or configuration that may be suitable for performing this function. For example, FIG. 5(a) is a perspective view of a cam disc 4811 that includes a single surface 4811a that includes a convex region 4811b. Such a cam disc 4811 may be suitable, for example, for use in a two-stroke engine that employs, as illustrated in FIG. 16, a main drive cam 141 having a single lobe 141a. FIG. 5(b) is a perspective view of a cam disc 4812 that includes a three surfaces 4812a, 4812b, 4812c, each of which includes a convex region 48121, 48122, 48123, respectively. Such a cam disc 4812 may be suitable, for example, for use in an engine that employs, as illustrated in FIG. 17, a main drive cam 142 having three lobes 142a, 142b, 142c, the third lobe being used to, e.g., drive the mechanical intensification of a unit type diesel injector.

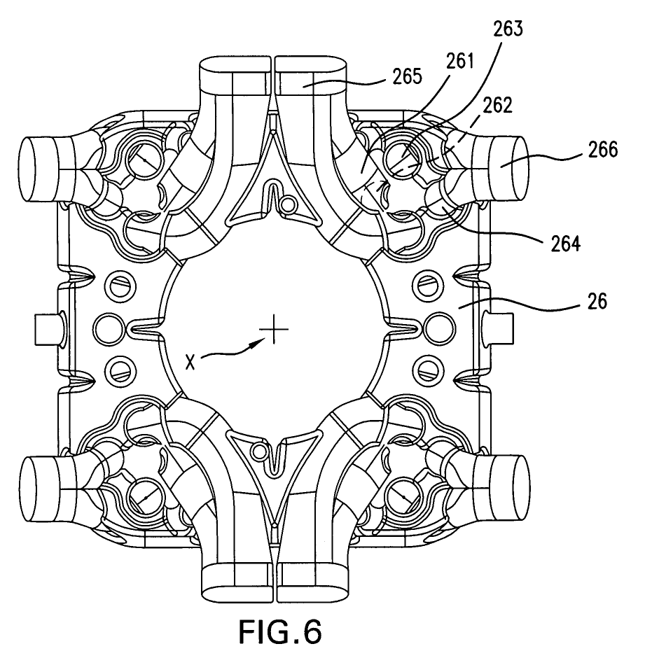

FIG. 6 is a longitudinal view of the block/head assembly 26 illustrating an arrangement of intake and exhaust ports. For example, and as illustrated in FIG. 6, the engine 10 may provide an arrangement in which, for each linear piston 20, there are two intake ports 261, 262 and two exhaust ports 263, 264. The two intake ports 261, 262 are radially closer to the central longitudinal axis (designated as “x”) of the main drive shaft 12 as compared to the exhaust ports 263, 264. Each one of the two intake ports 261, 262 and the two exhaust ports 263, 264 are substantially axially disposed, e.g., parallel with a longitudinal axis of the cylinder bores 22, at a first end at which they respectively communicate with the cylinder bore 22 (the cylinder bores 22 are hidden from view in FIG. 6, being on the opposite side of the block/head assembly 26). Moving away from their respective first ends, the two intake ports 261, 262 turn and join together into a single intake duct 265. Moving away from their respective first ends, the two exhaust ports 263, 264 turn and join together into a single exhaust duct 266. Single intake ducts 265 from two adjacent piston/cylinder bores may be arranged alongside each other so as to extend generally radially outward in a first direction, while single intake ducts 265 from the two other adjacent piston/cylinder bores are also arranged alongside each other so as to extend generally radially outward in a second direction, the second direction being opposite from the first direction. The single exhaust ducts 266, on the other hand, extend from the four corners of the arrangement such that single exhaust ducts 266 from two adjacent piston/cylinder bores extend generally radially outward in a third direction, the third direction being generally perpendicular to the first and second directions, while single exhaust ducts 266 from the two other adjacent piston/cylinder bores extend generally radially outward in a fourth direction, the fourth direction being opposite from the third direction.

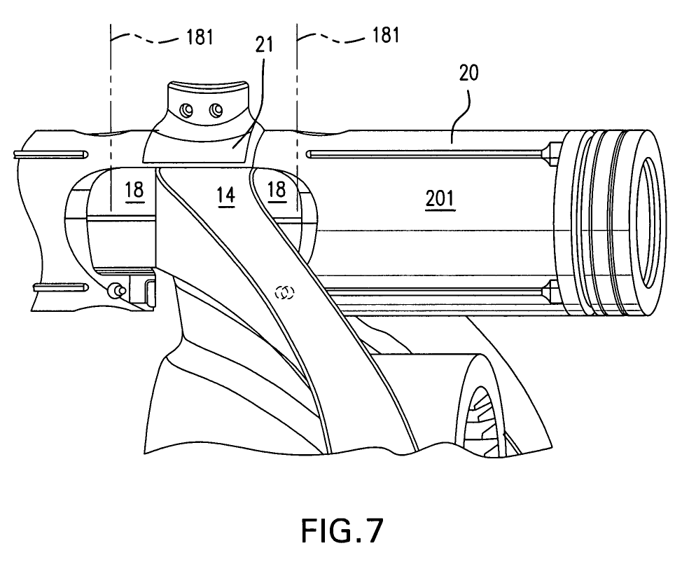

FIG. 7 is a partial view of the engine 10 which illustrates some additional details of the piston and main drive cam arrangement. FIG. 7 illustrates an engine 10 in which the pair of linear pistons 20 are connected to each other by the piston shank 21 such that the pair of aligned linear pistons 20 are integrally formed and may move as a single component. The linear pistons 20 have a centrally-disposed interior bore 201. Each cam roller 18 is rotatably mounted within the centrally-disposed interior bore 201 so as to rotate about an axis 181 that is perpendicular to the longitudinal axis of the linear pistons 20. The cam rollers 18 are mounted such that the main drive cam 14 may be situated therebetween.

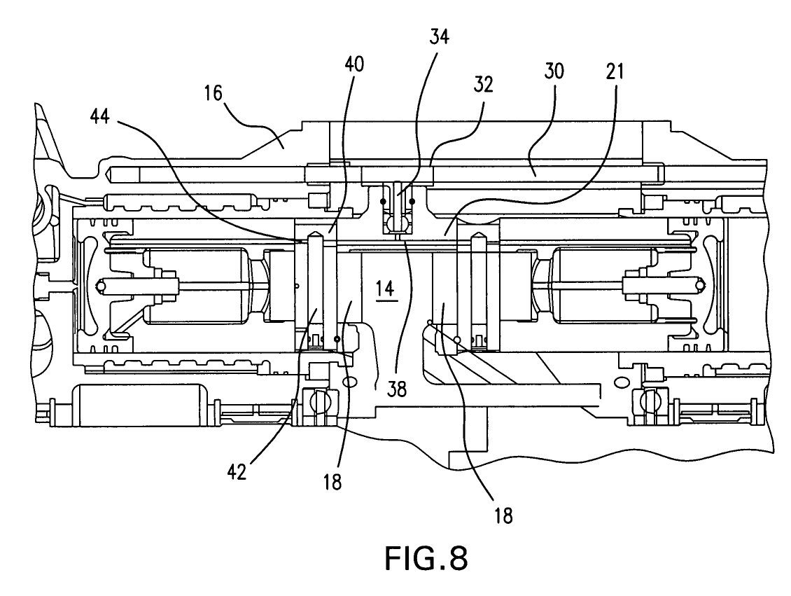

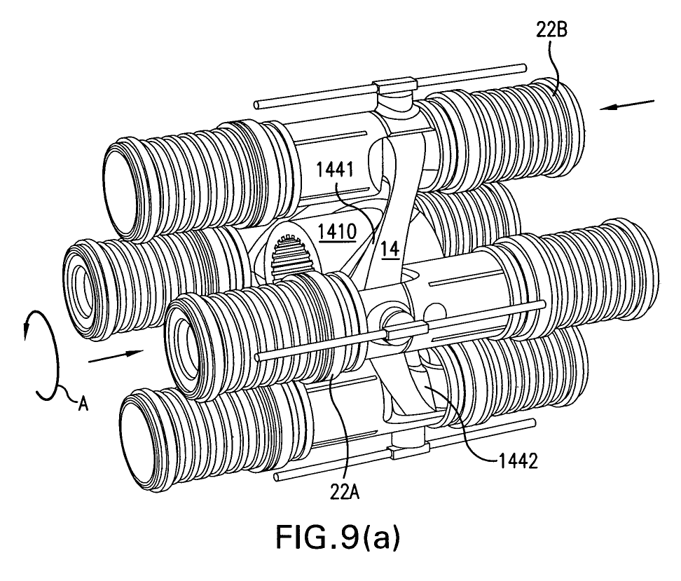

FIG. 8 is a partial cross-sectional view of the engine 10 which illustrates further details of the piston and main drive cam arrangement. FIG. 8 illustrates an engine 10, which includes a “trombone”-type lubrication system. For each pair of linear pistons 20, the outer housing 16 supports a tubular rod 30 that is disposed parallel to the longitudinal axis of the linear pistons 20. The tubular rod 30 may have an interior bore along its entire length such that, at both ends of the tubular rod 30, the interior bore is in fluid communication with an oil reservoir via the outer housing 16. A T-shaped slide member 32 is slidably mounted on the tubular rod 30 and has a hollow neck 34 that extends perpendicularly from the direction in which the slide member 30 move along the tubular rod 30. The piston shank 21 of the linear pistons 20 has a hollow neck 36 that extends in a direction that is perpendicular to the longitudinal axis of the linear piston 20, and a longitudinal bore 38 that is in fluid communication with the interior region of its hollow neck 36. The hollow neck 34 of the slide member 32 engages the hollow neck 36 of the piston shank 21 such that their respective interior regions form a fluid conduit between the interior bore of the tubular rod 30 and the longitudinal bore 38 of the piston shank 20. The longitudinal bore 38 of the piston shank 21 extends to the rollers 18.

Each roller 18 includes a cylindrical center dowel 40, which is rigidly mounted within, and perpendicularly arranged relative to, the interior bore 201 of the linear piston 20. The center dowel 40 has a central interior bore 42 that extends substantially through a portion of the center dowel 40, e.g., being plugged on a lower side so as t create a lubricating and cooling fluid reservoir. Extending radially relative to the central interior bore 42 are branch orifices 44 spaced at regular intervals along the central interior bore's 42 length. The branch orifices 44 are in fluid communication with the central interior bore 42. One or more of the branch orifices 44 align with the longitudinal bore 38 of the piston shank 21.

In operation, a lubrication fluid enters the hollow interior of the tubular rod 30 via the outer housing 16 and passes through the hollow neck 34 of the slide member 32. The fluid travels through the hollow neck 34 of the slide member 32 and into the hollow neck 36 of the piston shank 20, where it moves longitudinally through the bore 38. The fluid passes through the bore 38 and into aligned branch orifices 44 of the dowel 40. The fluid then passes into the central interior bore 42 of the roller's center dowel 40. From the central interior bore 42, the fluid passes through other ones of the branch orifices 44 where it provides lubrication to the roller 18 and cooling to other components of the pistons 20.

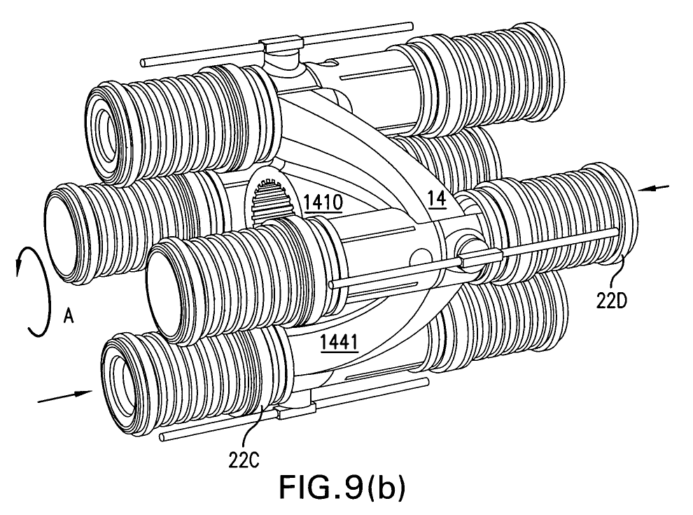

As set forth above, the engine 10 operates by the reciprocating linear movement of the linear pistons 20 within respective cylinder bores 22, so as to cause the cam members, e.g., rollers, 18 to move in a reciprocating linear fashion, the rolling contact of the cam members 18 with the surfaces 1441, 1442 of the sinusoidal main drive cam 14 causing the sinusoidal main drive cam 14 (and the main drive shaft 12 that is non-rotatably mounted therein) to rotate. The reciprocating linear movement of the linear pistons 20 is caused by combustion, suitably timed, within the cylinder bores 22. FIGS. 9(A) and 9(B) are partial exploded views of the engine 10, which illustrate the engine 10 in various stages of its operation.

For example, FIG. 9(A) illustrates the main drive cam 14 in a first rotational position. In this first rotational position, combustion occurs in the cylinder bores 22A and 22B. The combustion in the cylinder bores 22A and 22B causes reciprocating linear movement of the respective linear pistons 20 and cam rollers 18 that are disposed within the cylinder bores 22A and 22B, such that the rolling contact of the cam members 18 with the surfaces 1441, 1442 of the sinusoidal main drive cam 14 causes the sinusoidal main drive cam 14 (and the main drive shaft 12 that is non-rotatably mounted therein) to rotate in the direction indicated by arrow A. FIG. 9(B), on the other hand, illustrates the main drive cam 14 in a second rotational position. In this second rotational position, the main drive cam 14 (and the main drive shaft 12 which is non-rotatably connected to the main drive cam 14 via sleeve 1410) continues to rotate in the direction shown by arrow A. In this second rotational position, combustion occurs in the cylinder bores 22C and 22D. Further rotation of the main drive cam 14, and the attached main drive shaft 12, in the direction shown by arrow A results from continued and sequential combustion in the remaining cylinders 22.

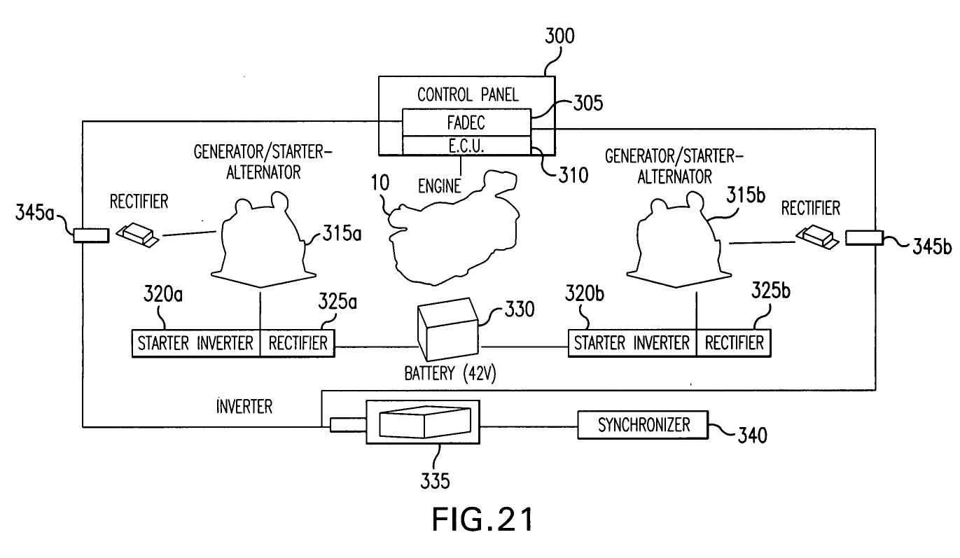

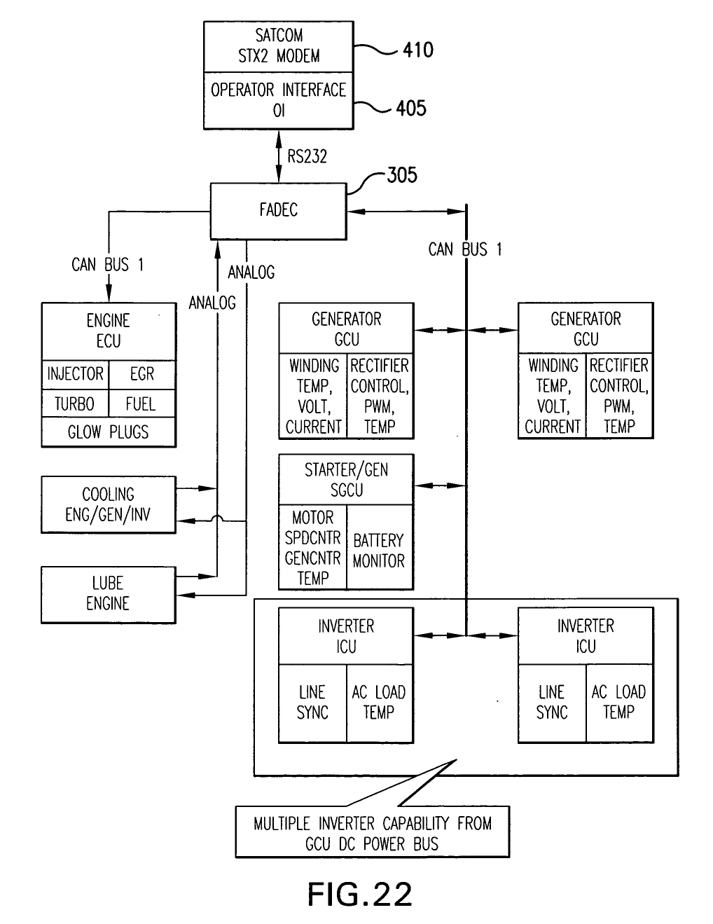

FIGS. 21 and 22 illustrate schematically a system, including a control arrangement, in which the engine 10 may be employed. As illustrated, the engine 10 may be electronically coupled to, and controlled by, a control panel 300. The control panel 300 may include a control unit (e.g., a “Full Authority Digital Electronic Control” or FADEC) 305 and an engine control unit 310. The FADEC 305 may be configured to process signals received from the various components of the system and to communicate with an engine control unit 310. The engine control unit 310 may be in electronic communication with the engine 10, sending and receiving signals to control various functions of the engine 10 based on, e.g., preprogrammed software, interactive operator input, engine feedback, etc. Also, the control panel 310 may be electronically coupled to, e.g., a pair of rectifiers 345a, 345b which are in turn coupled to an inverter 335 and a synchronizer 340 or to other electronic components.

The engine 10 may be coupled to a pair of generator/motors 315a, 315b. It should be recognized that a single generator/motor may be employed. One or both of the pair of generator/motors 315a/315b may operate as, e.g., a generator, a starter, an alternator, etc. The engine 10 and the pair of generator/motors 315a, 315b may be arranged such that each pair of generator/motors 315a, 315b is coupled to alternate ends of the main drive shaft 14. For example, a first generator/motor 315a may be coupled to the first longitudinal portion of the main drive shaft, and a second generator/motor 315b may be coupled to the second longitudinal portion of the main drive shaft. In this manner, the engine 10 may selectively employ either one or both of the pair of generator/motors 315a/315b depending on the desired function.

Referring back to FIG. 21, the generator/motors 315a, 315b may be electrically coupled to a respective starter inverter 320a, 320b and/or to a respective rectifier 325a, 325b. The respective starter inverter 320a, 320b and/or to a respective rectifier 325a, 325b may in turn be coupled to a battery 330, e.g., 42V.

FIG. 22 is a schematic view that illustrates a control signal arrangement of the system illustrated in FIG. 21. The FADEC 305 is shown as being in communication with various components of the system. For example, the FADEC 305 is shown as being in communication with an operator interface 405, which may in turn be in communication with a modem, e.g., a SATCOM STX2 modem. Also, the FADEC 305 may be in communication with various data bus which transmit signals, e.g., analog signals, between the FADEC 305 and various control units, e.g., the engine control unit, the generator control units, the inverter control units, etc.

As set forth herein, the barrel-type internal combustion engine may provide numerous advantages compared to conventional engines of this and other types. For example, having the direction in which the main drive shaft 12 lies parallel to the direction of the piston 20 movement may enable an arrangement wherein, by the pistons traveling in a linear motion, piston rings may be eliminated and the accompanying cylinder-side loading that is associated with the use of piston rings may be eliminated or reduced. Additionally, this may eliminate or reduce friction that may result from the conventional use of piston rings and the accompanying cylinder-side loading. Eliminating or reducing friction in this manner may improve engine efficiency, and may prevent premature wear which can lead to component failure in conventional engines. Along with any one or more of the various other features described herein, the engine of the present invention may provide improvements in efficiency and power.

The engine may also provide various advantages over conventional devices by virtue of the common pivot point for the intake and exhaust valves 50, 52. For example, and as illustrated in FIG. 4, the engine may provide an arrangement in which the gimbal 541 is connected to the pair of intake valves 50 via a rotatable arm 60 and the gimbal 542 is connected to the pair of exhaust valves 52 via a rotatable arm 56. The rotatable arms 56, 60 may be rotatable about a shared pivot 58. Specifically, the rotatable arm 56 is biased by valve springs 521 in order to rotate about the pivot point 58, thereby maintaining the roller 562 of the gimbal 542 in rolling contact with the cam surface 481b of the cam disc 48. The rotatable arm 60 is biased by valve springs 501 in order to rotate about the pivot point 58, thereby maintaining the roller 561 of the gimbal 541 in rolling contact with the cam surface 481a of the cam disc 48. By having the rotatable arms 56, 60 rotatable about a shared pivot 58, the space required to mount the two rotatable arms 56, 60 may be significantly reduced as compared to conventional engines, which typically employ separate arms for operating, e.g., opening and closing, the intake and exhaust valves, each separate arm being rotatable about different pivot points.

The engine may also provide various advantages over conventional devices by virtue of its cam disc arrangement. For example, and as illustrated in FIG. 4, the engine may provide an arrangement in which rollers 561, 562 of the gimbals 541, 542 are in rolling contact with cam surfaces 481a, 481b of the cam disc 48. By the connection via the rotatable arms 56, 60 of the gimbals 541, 542 to the intake and exhaust valves 50, 52, respectively, the alternating planar and convex regions of the surfaces 481a, 481b provide for precisely timed opening and closing of the intake and exhaust valves 50, 52. The use of such rollers and gimbals may provide for a relatively low friction arrangement as compared to conventional engines.

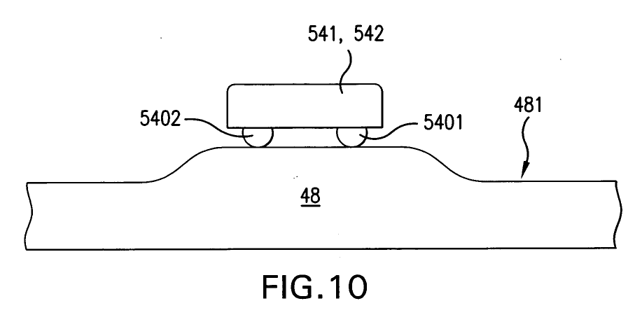

While FIG. 4 illustrates an arrangement in which each one of the gimbals 541, 542 include a single respective roller 561, 562, the engine 10 may alternatively employ an arrangement in which each one of the gimbals 541, 542 include two or more respective rollers. For example, FIG. 10 illustrates an arrangement in which a gimbal, e.g., gimbals 541, 542, includes two rollers 5401, 5402. In such an arrangement, each one of the rollers 5401, 5402 may be in rolling contact with a respective cam surface 481, e.g., cam surface 481a or 481b, of the cam disc 48. By using two or more such rollers 5401, 5402, velocity differences between surfaces having varying diameters may be overcome and/or loads that are carried by each one of the rollers may be reduced, thereby improving performance and reducing wear as compared to arrangements that employ a single roller for each gimbal.

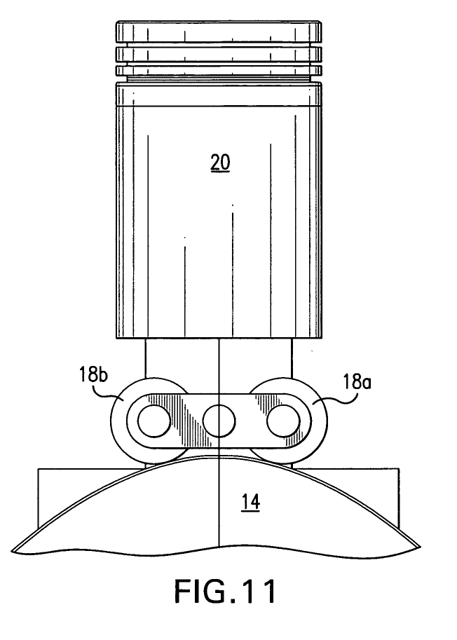

While FIG. 4 illustrates an arrangement in which each one of the linear pistons 20 include a single roller 18 located on and being in rolling contact with each side of the main drive cam 14, the engine 10 may alternatively employ an arrangement in which each one of the linear pistons 20 include, on each side of the main drive cam 14 and in rolling contact therewith, two or more respective rollers. For example, FIG. 11 illustrates an arrangement in which the linear pistons 20 include, on each side of the main drive cam 14, a pair of rollers 18a, 18b (for the purposes of clarity, FIG. 11 shows a single side of the main drive cam 14, and thus a single pair of rollers 18a, 18b). For example, referring to the rolling contact between the linear piston 20 and the main drive cam 14, the speed of a roller that is in contact with a first side 1441 of the main drive cam 14 may be different than the speed of a roller that is in contact with an opposite side 1442 of the main drive cam 14, because, at any given point in time, each roller is in rolling contact with a surface having a different curvature. This difference in speeds may result in loads and/or friction which are desired to be reduced. By using a tandem roller arrangement, velocity differences between surfaces having varying diameters may be overcome and/or loads that are carried by each one of the rollers may be reduced, thereby improving performance and reducing wear.

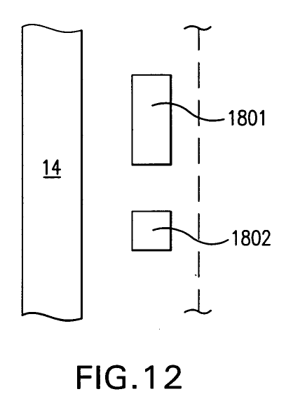

As shown in FIG. 1, the engine 10 may provide an arrangement in which each gimbal 541, 542 includes a single roller, e.g., 561, 562, respectively, and/or may provide an arrangement in which each linear piston 20 includes a single roller in contact with each side of the main drive cam 14. However, the engine 10 may instead employ an arrangement in which any one or more of these rollers is replaced by a tandem roller arrangement. For example, referring to the rolling contact between the linear piston 20 and the main drive cam 14, the speed of a roller that is in contact with a first side 1441 of the main drive cam 14 may be different than the speed of a roller that is in contact with an opposite side 1442 of the main drive cam 14, because, at any given point in time, each roller is in rolling contact with a surface having a different curvature. This difference in speeds may result in loads and/or friction which are desired to be reduced. By using a tandem roller arrangement, velocity differences between surfaces having varying diameters may be overcome and/or loads that are carried by each one of the rollers may be reduced, thereby improving performance and reducing wear. For example, FIG. 12 illustrates an arrangement that includes a main roller 1801 and a secondary roller 1802. The main roller 1801 may provide rolling contact with a given surface, e.g., surface 1441 of the sinusoidal main drive cam 14, during certain periods of the operation. During other times of the operation, e.g., when the load and/or friction experienced by the main roller 1801 is above, or is expected to be above, a desired amount, a secondary roller 1802 may also be brought into contact with the surface, thereby helping to reduce friction and/or reducing the load that would otherwise be experienced by the main roller 1801.

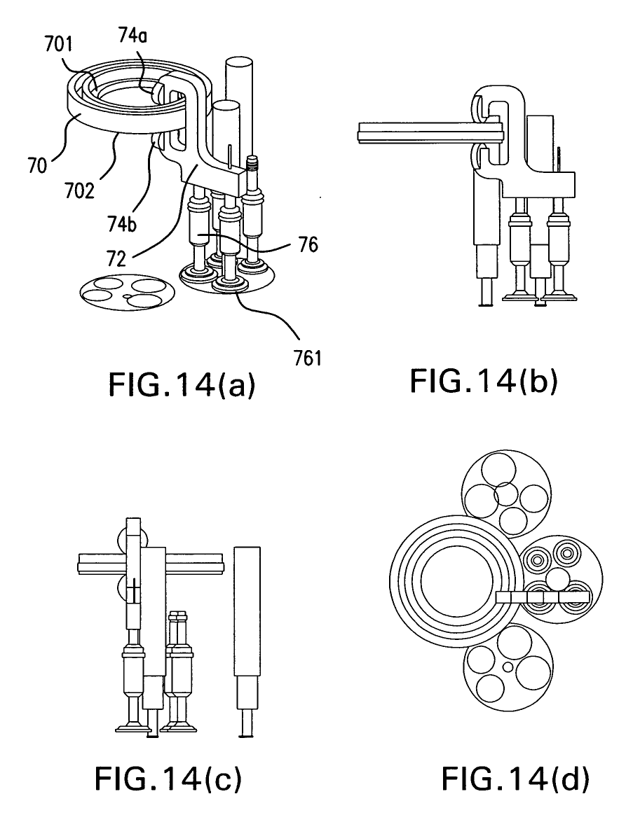

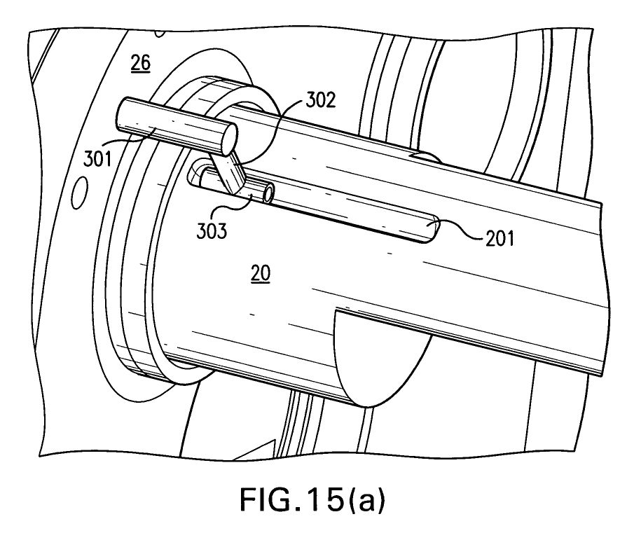

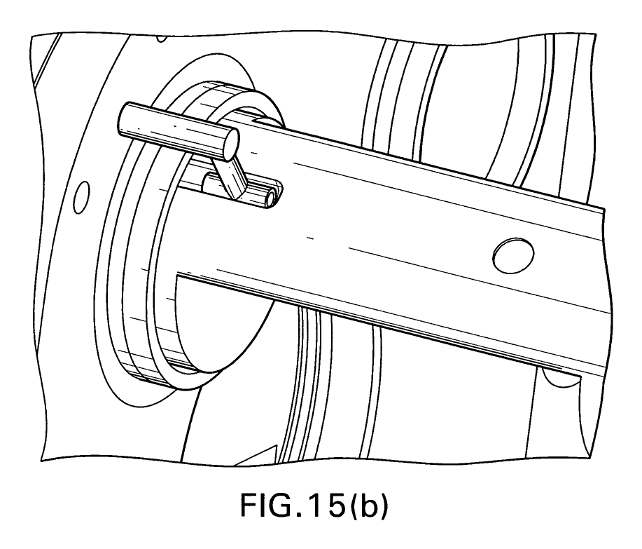

As shown in FIG. 4, the engine 10 may provide an arrangement in which the biasing force of valve springs 501, 521 of the intake and exhaust valves 50, 52 contribute to the actuation of the rotatable arms 56, 60. More specifically, the valve springs 501, 521 operate to close the intake and exhaust valves 50, 52 when the rollers 561, 562 of the gimbals 541, 542 are in rolling contact with a planar portion of the respective cam surfaces 481a, 481b of the cam disc 48. Alternatively, the engine 10 may employ direct actuation or “desmodromic”, valves. FIGS. 14(a) through (d) illustrate such an arrangement. For example, FIG. 14(a) is a perspective view of a cam disc 70 that has upper and lower surfaces, e.g., upper surface 701 and lower surface 702. FIGS. 14(b) through (d) illustrate side, front and top views, respectively, of the arrangement. An arm 72 includes a pair of rollers 74a, 74b, each one of which is in rolling contact with a respective one of the upper and lower surfaces 701, 702. Specifically, roller 74a is in rolling contact with the upper surface 701 and roller 74b is in rolling contact with the lower surface 702. The arm 72 is connected at its opposite end to intake and/or exhaust valves 76. In such an arrangement, the upper and lower surfaces 701, 702 may have a matching profile, e.g., each of the upper and lower surfaces 701, 702 includes planar portions at the same circumferential locations relative to each other, and the upper surface 701 may have a convex portion at the same circumferential position and to the same degree as the lower surface 702 has a concave portion. In this manner, the rollers 74a, 74b remain in rolling contact with their respective upper and lower surfaces 701, 702 at all times, the planar and convex/concave portions of the upper and lower surfaces 701, 702 causing the rollers 74a, 74b, and hence the arm 72 to which they are attached, to move according to the profile of the upper and lower surfaces 701, 702. The movement of the arm 72 causes longitudinal movement of the valves 76, thereby actuating the valves by moving the respective valve heads 761 of the valves 76 into and out of contact with respective valve seats. Such an arrangement may provide advantages over conventional devices. For example, such a direct actuation valve arrangement may reduce friction and improve performance.

The engine may also provide various advantages over conventional devices by virtue of the process by which the cam may be manufactured. For example, and as illustrated in FIG. 19, the engine may provide a cam having an arrangement that may be milled using a three-axis milling device. For example, a milling device may form the curved surfaces of the cam by moving in vertical and horizontal directions. In contrast, other cam-type engines have a cam that is required to be manufactured using complex and expensive five-axis milling technology. Although such five-axis milling technology may also be employed in the manufacture the cam hereof, the ability to manufacture the cam using less-complex and less-expensive three-axis technology may provide for manufacturing in facilities and regions that do not have access to or proficiency with five-axis milling technology, thereby reducing the cost and complexity of manufacturing, while improving the ability and likelihood of the engine being employed in such regions.

The engine of may also provide various advantages over conventional devices by virtue of its lubrication arrangement. For example, and as illustrated in FIG. 8, the engine 10 may provide lubrication via a “trombone”-type arrangement. In this arrangement, a constant supply of lubrication fluid is desired to be provided to a moving piston. As shown in FIG. 8, the tubular rod 30 on which the slide member 32 moves has an interior bore that is in fluid communication with an oil reservoir via the outer housing 16. The tubular rod 30 may be open on both its ends, e.g., it is in fluid communication with oil reservoirs at both locations at which it is mounted within the outer housing 16. In this manner, hydraulic forces that are experienced within the lubrication system are minimized. For example, such an arrangement may minimize the occurrence of cavitation, which typically occurs in conventional trombone-type lubrication arrangements when movement of a piston causes a rapid movement of, and consequently a vacuum within, the lubrication fluid.

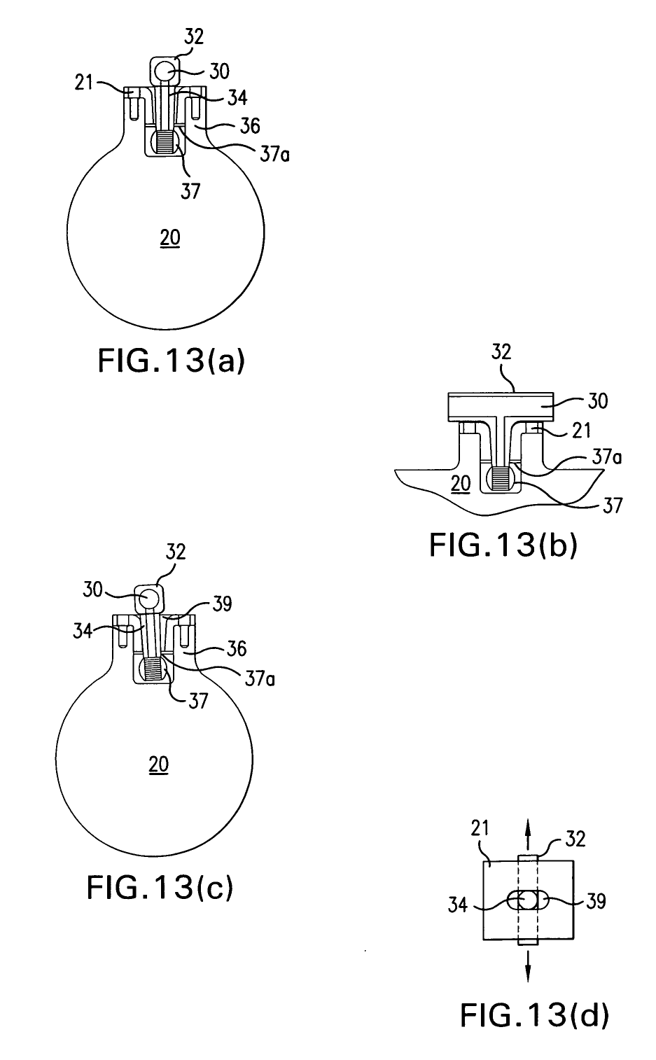

FIGS. 13(a) through (d) provide various views including additional details of a manner in which the hollow neck 34 of the slide member 32 may engage the hollow neck 36 of the piston shank 21. For example, FIG. 13(a) is a longitudinal cross-sectional view, and FIG. 13(b) is a side cross-sectional view, that show the hollow neck 34 of the slide member 32 engaging the hollow neck 36 of the piston shank 21 such that their respective interior regions form a fluid conduit between the interior bore of the tubular rod 30 and the longitudinal bore 38 of the piston shank 21. In this embodiment, a ball 37 is mounted on a threaded portion located at the lower end of the hollow neck 34 of the slide member 32, the ball 37 being sized so as to abut an internal shoulder 37a of the hollow neck 36 of the piston shank 21, thereby preventing the hollow neck 34 of the slide member 32 from disengaging the hollow neck 36 of the piston shank 21 and maintaining a sealed fluid conduit between the interior bore of the tubular rod 30 and the longitudinal bore 38 of the piston shank 21. As shown in FIG. 13(d), the opening of the hollow neck 36 of the piston shank 21 into which the hollow neck 34 of the slide member 32 is engaged may be configured as a slot 39. In this manner, and as shown in FIG. 13(c), the hollow neck 34 of the slide member 32 may still engage the hollow neck 36 of the piston shank 21, and may maintain a sealed fluid conduit between the interior bore of the tubular rod 30 and the longitudinal bore 38 of the piston shank 21, even when there is slight rotational displacement of the hollow neck 34 of the slide member 32 and the hollow neck 36 of the piston shank 21. As shown in FIG. 13(c), the ball 37 mounted on the threaded portion located at the lower end of the hollow neck 34 of the slide member 32 remains in abutment with the internal shoulder 37a of the hollow neck 36 of the piston shank 21 upon such rotational displacement, thereby maintaining a sealed fluid conduit between the interior bore of the tubular rod 30 and the longitudinal bore 38 of the piston shank 21. This arrangement provides for effective delivery of lubrication fluid to the afore-mentioned interior regions while providing the sliding movement of the slide member 32 along the tubular rod 30 in the manner described hereinabove.

It should be recognized that, while the engine 10 has been described hereinabove in connection with a lubrication arrangement of the trombone-type, various other lubrication arrangements may also be employed. For example, in FIGS. 15(a) and (b), there is illustrated an engine having a different kind of lubrication arrangement. Specifically, FIG. 15(a) illustrates a linear piston 20 having a slotted depression 201. A tubular rod 301 that extends longitudinally from the block/head assembly 26 has an interior bore therewithin which conveys lubrication fluid radially inwardly via hollow member 302 and then longitudinally again, within the slotted depression 201 of the linear piston 20, via the tube section 303. For the purposes of clarity, the piston liner 30, through which the radially-extending hollow member 302 may penetrate, is not shown in the view. However, it should be recognized that the piston liner 30 may provide some sealing such that lubrication fluid that is conveyed out of the tube section 303 and into the slotted depression 201 of the linear piston 20 is retained within the piston liner 30. FIG. 15(a) illustrates the linear piston 20 at a bottom dead center position, while FIG. 15(b) illustrates the linear piston 20 at a top dead center position. The length of the slotted depression 201, and the arrangement of, e.g., the tube section 303 within the slotted depression 201, may depend on the travel of the linear pistons 20, among other factors.

The engine may also provide various advantages over conventional devices by virtue of the multi-piece construction of its main drive shaft. For example, and as illustrated in FIG. 1, the engine 10 may provide an arrangement having a main drive shaft 12 that is formed from two separate main drive shaft portions 12a, 12b. The two main drive shaft portions 12a, 12b are coupled to each other by any suitable coupling arrangement. By providing a two (or more) piece construction for the main drive shaft 12, the main drive shaft 12, and thus the engine 10 as a whole, may be more easily sized to larger outputs. More specifically, the main drive shaft 12 may be heat treated for greater durability and wear characteristics, and conventional heat treat ovens are generally not equipped to house the large main drive shafts that may be employed in some large applications of the engine 10. Thus, a 56-inch main drive shaft, such as may be employed in a conventional engine for providing an output of, e.g., 200 kW, may not be able to be treated in a conventional oven, which typically has a capacity to treat at most a shaft having a length of about 42 inches. However, a similar 56-inch main drive shaft, such as may be employed in engine 10, may be treated in a conventional 42-inch length oven by virtue of its ability to be dismantled into two or more portions, each portion of which is less than 42 inches in length. It should be recognized that such manufacturing constraints as the size of conventional ovens, etc., may vary. It should be noted that this feature may also provide for replacement of portions of the main drive shaft rather than the whole, thereby reducing the cost and complexity of repairs and maintenance of the engine 10.

The engine may also provide various advantages over conventional devices by virtue of its four cylinder/eight pistons arrangement. For example, and as illustrated in FIG. 3, the engine may provide an arrangement having four pairs of linear pistons, each pair of linear pistons disposed on opposite sides of respective cam members, e.g., rollers, for reciprocating linear movement within respective cylinder bores. As shown in FIG. 3, the pairs of linear pistons, and the respective cylinder bores in which the linear pistons are disposed, are symmetrically arranged about the central longitudinal axis of the main drive shaft, e.g., being radially equidistant about, and circumferentially equally spaced about, the central longitudinal axis of the main drive shaft axis. This symmetrical arrangement of the four pairs of linear pistons and respective cylinder bores about the central longitudinal axis of the main drive shaft may provide for a fully balanced engine, e.g., an engine with substantially no external vibration and/or which imparts substantially no forces on the engine's supporting structures. This is possible because any forces that are imparted by a particular component of the engine, e.g., a particular piston moving within its respective cylinder, are balanced by equal forces that are imparted by the other components of the engine that are symmetrically arranged about the central longitudinal axis of the main drive shaft and on opposite sides of the main drive cam 14. In contrast, conventional engines are not symmetrical at all and therefore provide no such balancing of forces, resulting in substantial amounts of engine vibration and support-borne forces. Even conventional cam drive axial piston type engines, e.g., that employ twelve pistons in six respective cylinder bores, do not provide a fully balanced engine because the angular spacing thereof is not conducive to such balancing, e.g., six cylinder pairs and a two lobe cam would cause a 30 degree difference between firing pulses from side to side, while conventional single-sided engines are markedly unbalanced since all firing forces are in one direction.

This symmetrical arrangement of the four pairs of linear pistons and respective cylinder bores about the central longitudinal axis of the main drive shaft may provide for still further advantages as compared to conventional devices. For example, this symmetrical arrangement of the four pairs of linear pistons and respective cylinder bores about the central longitudinal axis of the main drive shaft may provide for a substantial reduction, e.g., elimination, of thrust forces on the engine's main drive shaft. Again, this follows because any thrust forces that are imparted by particular components on a first side of the cam of the engine, e.g., the thrust force imparted to the main drive shaft by a particular piston firing within its respective cylinder, are balanced by equal and opposite thrust forces that are imparted by the other components of the engine that are arranged on an opposite side of the cam. In contrast, conventional engines are not symmetrical at all and therefore provide no such balancing of thrust forces on the main drive shaft, resulting in substantial amounts of engine wear. Even conventional cam drive axial piston type engines, e.g., that employ twelve pistons in six respective cylinder bores, do not provide a substantially thrust-free main drive shaft because the components are not sufficiently balanced in the relevant directions.

The engine may also provide various advantages over conventional devices by virtue of its compatibility with arrangements that employ a different number of strokes. For example, and as illustrated in FIGS. 2(a) through (d), the engine may provide an arrangement having a sinusoidal main drive cam 14 that includes two lobes. Such a two-lobe arrangement of the sinusoidal main drive cam 14 may be employed in a four stroke engine as described hereinabove. Engine 10 may employ a sinusoidal main drive cam 14 having a different number of lobes, thereby providing operation of the engine with a different number of strokes. For example, FIG. 16 is a perspective view of a main drive cam 141 mounted on a shaft 12. The main drive cam 141 has a single lobe 141a. Such an arrangement of the main drive cam 141 may be employed in a two stroke engine. FIG. 17 is a perspective view of a main drive cam 142 mounted on a shaft 12. The main drive cam 142 has three lobes 142a, 142b, 142c. Such an arrangement of the main drive cam 141 may be employed in a six stroke engine. It should be recognized that the main drive cam may have any number of lobes so as to accommodate, and provide for operation of, an engine having a particular number of strokes. Furthermore, the shape of the main drive cam 14 can vary to provide different power profiles, e.g., more torque may be generated by the addition of more lobes to the cam, and changes may be made to the profile to better accommodate the pressure applied to the main drive cam 14 by the proximal movement of the linear pistons 20 during combustion. Different shapes and dimensions of the main drive cam 14 may result in new power profiles and each cam profile may be optimized for a specific application. For example, an engine powering a generator may operate via the delivery of constant speed and torque while an engine powering a surface vehicle may operate via the delivery of torque and acceleration. Thus, by virtue of its compatibility with arrangements that employ a different, e.g., any even number, of strokes, the engine may provide a cost-effective way to run multi-stroke engines.

The engine may also provide various advantages over conventional devices because it provides a single-part transmission. For example, and as illustrated in FIG. 1, the engine of the present invention may provide an arrangement that, unlike conventional engines, does not need a gear reduction arrangement in order to motor the load. Conventional engines typically employ a transmission that includes various components, e.g., speed changing gears, in order to transmit power from an engine to a live axle. This transmission significantly increases the complexity and weight of the system, e.g., an automobile, in which it is employed. In contrast, the engine hereof may provide an arrangement that, unlike these conventional engines, dispenses with the conventional transmission, e.g., the gear reduction components, by providing direct transmission of the engine 10's output to its rotating shaft 12.

The engine may also provide various advantages over conventional devices by virtue of its liner retaining nut. For example, and as shown in FIG. 1, the engine 10 may employ a liner retaining nut 31 that functions to retain each one of the liners 30 within its respective cylinder bore 22. In this manner, the liner retaining nut 31 may prevent the operation of each one of the linear pistons 20 within their respective cylinder bores 22 from causing undesired movement of, or excessive wear of, either one or both of the linear pistons 20 and the cylinder bores 22.

The engine may also provide various advantages over conventional devices by virtue of its arrangement of the intake and exhaust ports. The configuration of the intake and exhaust ports and their respective intake and exhaust ducts may be arranged so as to be segregated from each other, thereby better managing the heat of the exhaust. For example, and as illustrated in FIG. 6 and described above, the engine 10 may provide an arrangement wherein, for each linear piston 20, there are two intake ports 261, 262 and two exhaust ports 263, 264, the two intake ports 261, 262 being radially closer to the central longitudinal axis (designated as “x”) of the main drive shaft 12 as compared to the exhaust ports 263, 264. Each one of the two intake ports 261, 262 and the two exhaust ports 263, 264 may be substantially axially disposed, e.g., parallel with a longitudinal axis of the cylinder bores 22, at a first end at which they respectively communicate with the cylinder bore 22 (the cylinder bores 22 are hidden from view in FIG. 6, being on the opposite side of the block/head assembly 26). Moving away from their respective first ends, the two intake ports 261, 262 may turn and join together into a single intake duct 265. Moving away from their respective first ends, the two exhaust ports 263, 264 may turn and join together into a single exhaust duct 266. As illustrated, single intake ducts 265 from two adjacent piston/cylinder bores are arranged alongside each other so as to extend generally radially outward in a first direction, while single intake ducts 265 from the two other adjacent piston/cylinder bores are also arranged alongside each other so as to extend generally radially outward in a second direction, the second direction being opposite from the first direction. The single exhaust ducts 266, on the other hand, extend from the four corners of the arrangement such that single exhaust ducts 266 from two adjacent piston/cylinder bores extend generally radially outward in a third direction, the third direction being generally perpendicular to the first and second directions, while single exhaust ducts 266 from the two other adjacent piston/cylinder bores extend generally radially outward in a fourth direction, the fourth direction being opposite from the third direction. In this manner, the relatively hotter exhaust ports and ducts are segregated from the cooler intake ports, thereby minimizing any undesirable heating of the valves and other associated structures, e.g., valve seats.

The engine may also provide various advantages over conventional devices because it employs rollers that are in rolling contact with the sinusoidal main drive cam 14. For example, and as illustrated in FIG. 1, the engine may provide an arrangement in which rollers 18 engage the sinusoidal main drive cam 14. In contrast, conventional cam-driven barrel-type engines have employed bushing that engage a sinusoidal main drive cam. However, the use of such bushings may be ineffective in that the loads experienced by the bushings, via engagement with a main drive cam, are higher than may practically be handled by a bushing. Furthermore, the use of rollers 18 in the engine hereof is facilitated by the lubrication arrangement described herein.

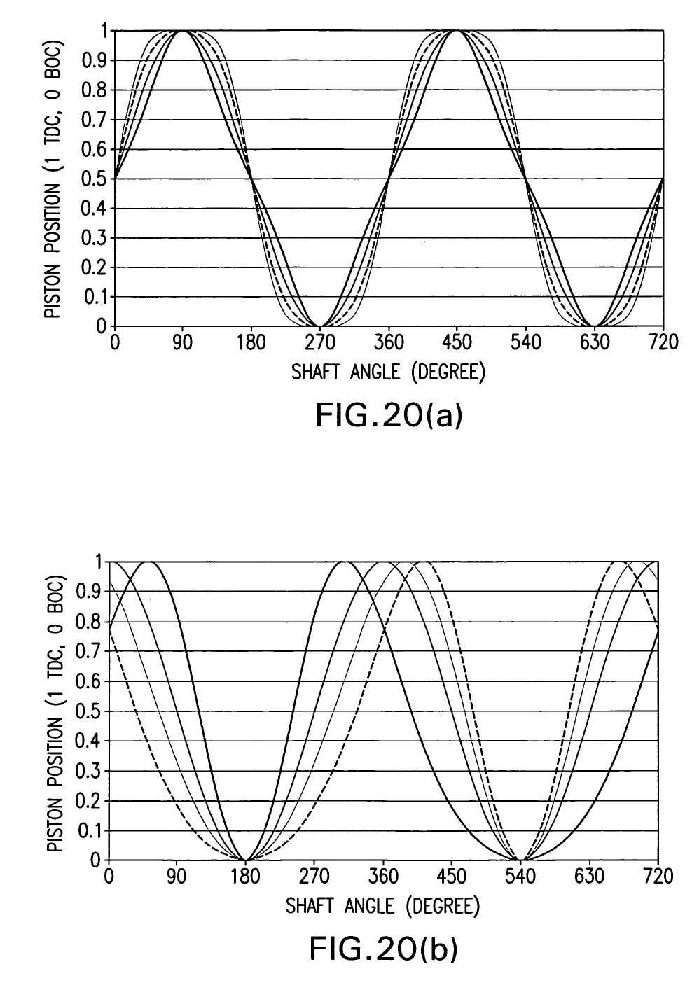

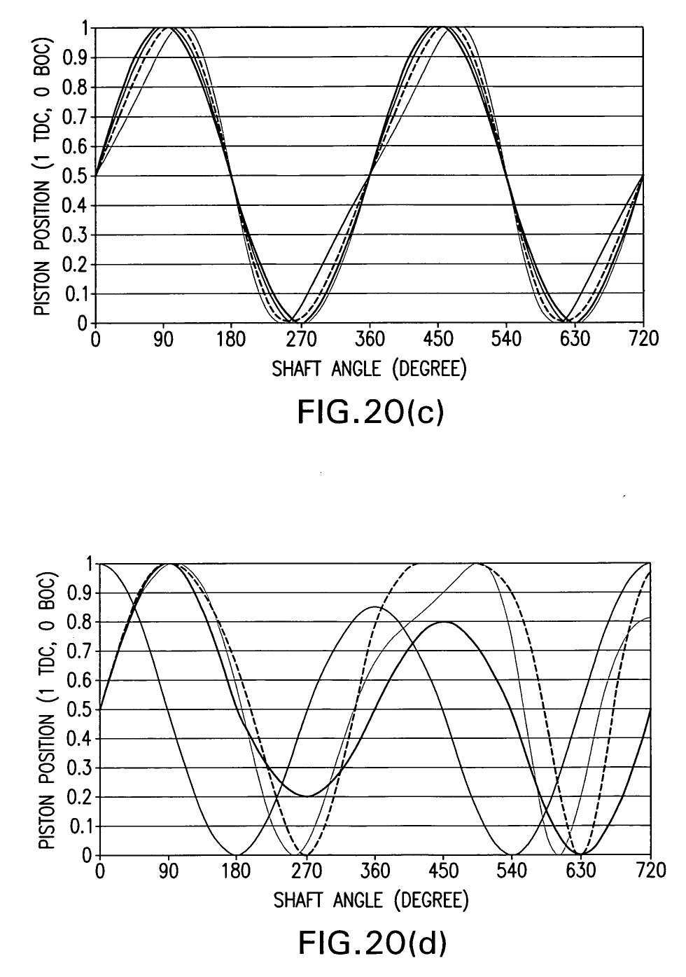

The engine may also provide various advantages over conventional devices by virtue of its ability to optimize its piston stroke. For example, the shape and profile of the main drive cam 14 may be selected so as to optimize a particular performance parameter. For example, FIGS. 20(a) through (d) illustrate performance characteristics that may be achieved by using varying shapes of, e.g., the main drive cam 14. As shown, depending on a particular performance that is desired to be achieved, the main drive cam 14 may be shaped so as to result in, e.g., a shorter or longer stay for the pistons at top-dead-center or bottom-dead-center, variations in the duration or speed of a piston, etc.

The engine may also provide various advantages over conventional devices by virtue of its two-sided, e.g., mirror-image, arrangement. For example, and as illustrated in FIG. 1, the engine hereof may provide an arrangement in which, for each linear piston 20 that is arranged on a first side of the main drive cam 14, there is another linear piston 20 that is arranged on the opposite side of the main drive cam 14. This two sided architecture provides for a compact and versatile operation. For example, in addition to the operation of the engine 10 as set forth hereinabove, the engine may be configured to operate in various different manners. With a cylinder having a piston at both ends, it is possible to operate the engine such that torque is produced only at a first end of the engine. Thus, there may be provided an arrangement in which the pistons at a second end of the cylinder may be used to carry out other tasks, such as pumping (single or multiple stage) hydraulic fluids or pneumatics or electrical power generation for various applications; such as propulsion of a vehicle, pumping irrigation water, or acting as a dedicated power generator for home and industrial applications.

It should be recognized that with the use of a suitable control system, the engine 10 may be configured to operate in various different manners. For example, the engine 10 may be controlled by a digital signal processor. The digital signal processor may be capable of measuring all aspects of engine operation. For example, the digital signal processor may measure a fuel temperature, pressure and consumption, a linear encoder position, a rotary position of the main drive shaft, emissions, oil temperature and engine airflow. Control of an engine may be fully electronic and any desired measurement may be measured and received by the digital signal processor. For example, the addition of a fuel viscosity sensor to measure the viscosity of the fuel may allow the engine to use any combination of diesel, JP5 or JP8.

The digital signal processor may control any one or more, e.g., all, devices. For example, the digital signal processor may provide control signals to a piezoelectric actuator intake valve, a piezo actuator exhaust valve, a piezo actuator fuel injector, a plasma ignition and/or any devices employed for power conversion and generation, etc.

Such a digital signal processor may also determine the control and performance of the engine. Control and engine performance may be dependent on a multitude of variables. The control system may adjust the system performance in an effort to achieve an optimum stoichiometric ratio, in order to maximize combustion efficiency. Variables that may be adjusted may include the start of fuel injection, frequency and amount of fuel injected and the closing and opening of the intake and exhaust valves 50, 52, etc.

Furthermore, total electronic control may allow the engine 10 to operate in different modes. For example, different modes may involve eliminating combustion, opening and closing of, e.g., electrically-operated valves, and/or utilizing the low internal friction of the engine. For example, the engine 10 may be able to coast by opening of one or more valves and eliminating combustion. Since maintaining speed may employ less power, the digital signal processor, in some embodiments, can also selectively fire cylinders to maintain speed. The digital signal processor may also selectively close to produce resistance and stop the engine.

Still further, a digital signal processor may also switch between 4 and 2 stroke operation. This may be accomplished by adjusting the timing of the intake and exhaust valves 50, 52 and the timing of the fuel injection. By switching to 2 stroke operation the engine may generate significantly more power.

Again, and as set forth above, another mode of operation may utilize pistons and cylinders for auxiliary or ancillary operations. Pistons and cylinders may be made to selectively operate as pumps and/or may provide compressed air for the other cylinders and/or perform as a linear supercharger. The digital signal processor may continue to control combustion and power generation in the remaining cylinders while the pistons and cylinders being utilized for auxiliary or ancillary operations may be driven directly from the main drive cam.

In those arrangements that employ such functionality, utilization by the engine 10 of pistons and cylinders for other functions is generally highly efficient. For example, in a conventional supercharger operation, a supercharger belted to the drive shaft supplies compressed air to the intake valves. The belt and pulley arrangements typically result in large losses and cannot be easily disengaged. In contrast, in the engine hereof, the utilization of one or more pistons and cylinders as a linear supercharger enables power to be delivered directly from the main drive cam 14 to the linear pistons 20. When the supercharger is not required, the intake and exhaust valves 50, 52 may be opened and the majority of the load is removed from the engine 10.

The ability to selectively open and close valves and the low internal friction may allow for the engine 10 to be self-starting. Rather than determining the piston position via the rotary position of the main drive shaft, the piston position may instead be determined by, e.g., a linear encoder mounted on the linear power shaft. The digital signal processor may determine which linear piston 20 is in the proper position for combustion, fuel is injected into the determined cylinder and is ignited by, e.g., the plasma ignition. In such an arrangement, the engine 10 may use very little starting torque due to, for example, the low internal friction, the possible elimination of piston rings, the elimination of intake and exhaust valve resistance, etc.

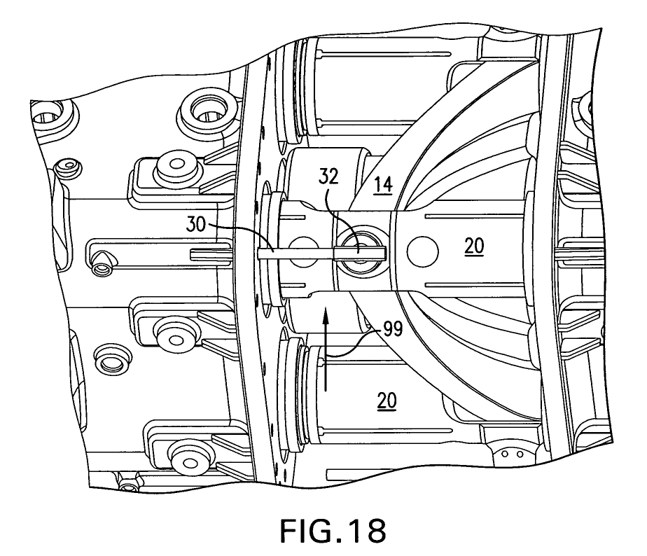

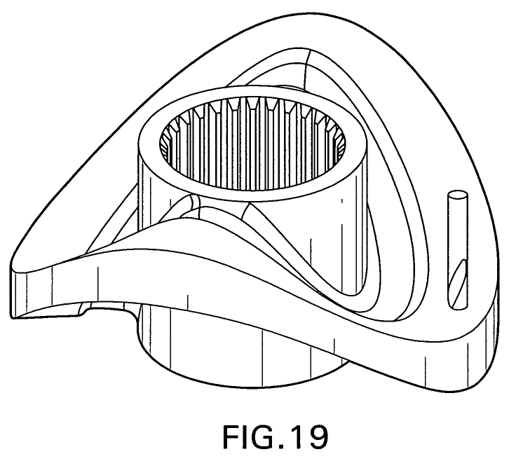

Also, the engine 10 may further provide for various methods of generating electrical power. For example, a built-in rotary generator/motor can be mounted to the engine 10. FIG. 18 illustrates an arrangement of the engine 10 which is configured with a built-in generator/motor 99. In such an arrangement, the generator/motor 99 may include coils that are suitably coupled to the main drive shaft 12. A generator/motor 99, which may be employed in such an arrangement of the present invention, is shown and described in U.S. patent application Ser. No. 11/523,188, entitled “Generator and/or Motor Assembly,” filed on Sep. 18, 2006, which is expressly incorporated herein in its entirety by reference thereto. As a generator, the engine may produce both rotational power and electrical power. The engine may also be driven by the electrical generator by switching leads and converting the generator into a motor. This may allow the engine to operate as a hybrid engine or operate in a so-called limp home function and drive the main drive shaft 12. Even a small generator operating as a motor may effectively drive the engine 10 since the motor has very little internal resistance when, e.g., a digital signal processor is employed to open the valves.

As an alternative, one or more of the linear pistons 20 may operate as linear electric generators for production of electrical energy. In such a configuration, a magnet mounted to the piston rod passes through windings of a generator located around the piston rod. Electrical energy is produced when the linear piston 20 is actuated. Also, the linear piston 20 may be driven, e.g., by reversing the windings and using the windings and the magnet as a linear motor.

The engine may be used in various applications including refrigeration, compressors and electric generator, etc. It may be provided that a single engine could supply multiple sources of energy. For example, the main drive shaft 12 may provide, e.g., rotational energy, an internal generator may provide, e.g., electrical energy, and selected pistons and cylinders may provide, e.g., hydraulic energy.

The engine may have many different applications. For example, with its torque band and light weight, the engine may allow for truly hybrid electrical and hydraulic vehicles. Also, the engine may be employed in military applications, ultra-efficient electrical power generation, automotive and transportation sectors, industrial, e.g., fixed and mobile, diesel-electric locomotive, small engine applications including maritime craft, recreational vehicles, pumping and compression applications.

In addition to the ultra-high efficiency electrical generator capabilities, the engine may provide AC load management, selective piston firing based upon sensed AC load, lowest cost/kilowatt hour, multi-fuel design especially attractive to, e.g., military, developing or third world nations, may provide significantly reduced weight/size. Also, non-historic vehicular installations may be provided by the engine. Still further, the engine may provide a broad product range, e.g., 7.5 kW, 15 kW, 25 kW, 50 kW, 100 kW, 200 kW and 1 MW and/or combination units. The engine may be employed for power generation/hydraulics, power generation/air compressor, etc. The relatively low part count of the engine may provide that the engine may be produced in large numbers, e.g., at high volume.

What is claimed is:

1. A system, comprising:
an engine that includes:
a main drive shaft defining a longitudinal axis, the main drive shaft having a first longitudinal portion and a second longitudinal portion;
a sinusoidal main drive cam non-rotatably attached to the main drive shaft;
a cylinder bore, a first portion of the cylinder bore being disposed on a first side of the sinusoidal main drive cam and a second portion of the cylinder bore being disposed on a second side opposite the first side of the sinusoidal main drive cam;
a pair of linear pistons, each linear piston being disposed in a respective one of the first and second portions of the cylinder bore; and
mounted to each piston, a cam member that engages the sinusoidal main drive cam, reciprocating linear movement of each piston and its respective roller in a direction parallel to the longitudinal axis causes the respective cam member to be in contact with the sinusoidal main drive cam for rotating the sinusoidal main drive cam and the main drive shaft;
a first generator coupled to the first longitudinal portion of the main drive shaft; and
a second generator coupled to the second longitudinal portion of the main drive shaft.

2. The system of claim 1, further comprising a control system for selectively using cam members located on a first side of the sinusoidal main drive cam for generating torque and using cam members located on a second side of the sinusoidal main drive cam for a function other than generating torque.

3. The engine of claim 1, wherein the cam member is a roller.

4. The engine of claim 1, wherein the cylinder bores are radially disposed around the main drive shaft in a generally circular pattern.

5. The engine of claim 1, further comprising a block/head assembly including intake valves configured to supply intake air to respective cylinder bores.

6. The engine of claim 5, further comprising a block/head assembly including exhaust valves configured to exhaust respective cylinder bores.

7. An engine, comprising:
a main drive shaft defining a longitudinal axis;
a sinusoidal main drive cam rigidly attached to the main drive shaft;
a plurality of cam members that are in contact with the sinusoidal main drive cam and that are configured to follow the sinusoidal main drive cam, rotation of the sinusoidal main drive cam corresponds to reciprocating linear movement of each cam member in a direction parallel to the longitudinal axis;
for each cam member, a pair of linear pistons disposed on opposite sides of the cam member for reciprocating linear movement within respective cylinder bores; and
a control system for selectively using cam members located on a first side of the sinusoidal main drive cam for generating torque and using cam members located on a second side of the sinusoidal main drive cam for a function other than generating torque.

8. The engine of claim 7, wherein the cam members are rollers.

9. The engine of claim 7, wherein the cylinder bores are radially disposed around the main drive shaft in a generally circular pattern.

10. The engine of claim 7, further comprising a block/head assembly including intake valves configured to supply intake air to respective cylinder bores.

11. The engine of claim 10, further comprising a block/head assembly including exhaust valves configured to exhaust respective cylinder bores.

12. The engine of claim 11, wherein each valve is held in a pre-stressed closed position by a compressed spring.
